(19) United States
(12) Patent Application Publication
(10) Pub. No.: US 2020/0070471 A1
(43) Pub. Date: Mar. 5, 2020

(54) COMPOSITE MATERIAL FOR FOOTWEAR

(71) Applicant: Kai-Hsi TSENG, Changhua County (TW)

(72) Inventor: Kai-Hsi TSENG, Changhua County (TW)

(21) Appl. No.: 16/121,001

(22) Filed: Sep. 4, 2018

(51) Int. Cl. B32B 5/26; A43B 5/00; A43B 1/14; A43B 13/02; A43B 13/04; A43B 13/12; B32B 5/12

(52) U.S. Cl. CPC B32B 5/26; B32B 2437/02; A43B 1/14; A43B 13/026; A43B 13/04; A43B 13/12; B32B 5/12; B32B 2250/03; B32B 2250/20; B32B 2250/40; B32B 2260/023; B32B 2260/046; B32B 2262/0269; B32B 2262/101; B32B 2262/106; B32B 2307/554; B32B 2307/546; A43B 5/00

(57) ABSTRACT

Provided is a composite material for footwear. The composite material comprises a first carbon fiber layer, a second carbon fiber layer, an intermediate layer, and a resin body. The first carbon fiber layer comprises multiple carbon fibers. The second carbon fiber layer comprises multiple carbon fibers, and the second carbon fiber layer is disposed above the first carbon fiber layer. The intermediate layer comprises an aramid fiber, a liquid crystal polymer fiber, or any combination thereof; the intermediate layer is disposed between the first carbon fiber layer and the second carbon fiber layer. The first carbon fiber layer, the second carbon fiber layer, and the intermediate layer are enclosed by the resin body. The composite material for footwear has good bendability and good wear resistance to enhance the quality of the sole or shoe boards made from the composite material.

### BACKGROUND OF THE INVENTION

### 1. Field of the Invention

The present invention relates to the technical field of a composite material, more particularly to a composite material for footwear.

### 2. Description of the Prior Arts

Major materials for footwear on the market are epoxy resins and thermoplastic polyurethane (TPU), both of which have been used for about 20 years. Epoxy resins and/or TPU materials can relieve the pressure on feet and improve the wearing comfort in wear. Therefore, they are widely used in various kinds of athletic shoes and sneakers, such as golf shoes, basketball shoes, soccer shoes, cycling shoes and jogging shoes.

However, when shoes made from the foresaid conventional materials are used over a period, they are easily deteriorated or aged due to environmental factors such as temperature changes, humidity changes, and solar radiation. When subjected to an external force of friction, impact, or bending beyond the maximum endurable force, the sole or heels would be broken. As a result, the user may get injured during the motion because of the breakage of the sole or the heels.

Therefore, there is still a need to improve the material for footwear.

### SUMMARY OF THE INVENTION

In view of the above-mentioned drawbacks of the prior arts, one objective of the present invention is to provide a composite material for footwear. The composite material for footwear has good bendability and good wear resistance, so as to improve the quality of the footwear and extend the service life. Therefore, the safety of the wearer is improved.

To achieve the foresaid objective, the present invention provides a composite material comprising a first carbon fiber layer, a second carbon fiber layer, an intermediate layer, and a resin body. The first carbon fiber layer comprises multiple carbon fibers. The second carbon fiber layer comprises multiple carbon fibers, and the second carbon fiber layer is disposed above the first carbon fiber layer. The intermediate layer comprises an aramid fiber, a liquid crystal polymer fiber, or any combination thereof; the intermediate layer is disposed between the first carbon fiber layer and the second carbon fiber layer. The first carbon fiber layer, the second carbon fiber layer, and the intermediate layer are enclosed by the resin body.

By the above technical means, the multiple carbon fibers of the first and second carbon fiber layers with higher mechanical strength can maintain the structural stability of the shoes so as to protect the wearers' feet. The intermediate layer has a good cushioning ability and high wear resistance, so it acts as an auxiliary to enhance flexibility and cushioning ability of footwear.

Preferably, the resin body comprises a polyamide resin (PA), a thermoplastic polyurethane resin (TPU), a polyetherimide resin (PEI), a polysulfone resin (PSU), a polyphenylene sulfone resin (PPSU), a polyethylene resin (PE), a polycarbonate resin (PC), an acrylonitrile-butadiene-styrene resin (ABS), or any combination thereof.

More specifically, the polyamide resin comprises Polyamide 6 (i.e. Nylon 6) or Polyamide 66 (i.e. Nylon 66). Polyamide 6 is synthesized by ring-opening polymerization of ε-carprolactam, and Polyamide 66 is synthesized by polycondensation of equivalent amounts of hexamethylenediamine and adipic acid.

The composite material can be modified according to the various applications of the shoes. Adjusting the arrangement of the carbon fibers, mixing different materials of fibers with carbon fibers, or using different resin bodies can be adopted to meet the needs of the tensile strength, structural stability, elasticity or hardness, and so on. For example, basketball shoes need to have good shock absorption, stability and elasticity; running shoes need to have a good flexibility and good elasticity; ice skates need to have a desired hardness to prevent the reverse insertion of blades. Preferably, the first carbon fiber layer is a first carbon fiber cloth, and the first carbon fiber cloth comprises the carbon fibers; the second carbon fiber layer is a second carbon fiber cloth, and the second carbon fiber cloth comprises the carbon fibers. To strengthen or improve the properties of the composite material, the first carbon fiber layer or the second carbon fiber layer can further comprise additional kinds of fibers by mixed weaving or blended spinning. That is, the first carbon fiber cloth or the second carbon fiber cloth comprises additional kinds of fibers, such as glass fibers or aramid fibers (i.e. poylmetaphenyleneisophthalamides, MPIA).

In some cases, the first carbon fiber layer can further comprise an inorganic fiber such as a glass fiber. In some cases, the first carbon fiber layer can further comprise an aramid fiber. Similarly, the second carbon fiber layer can further comprise an aramid fiber or an inorganic fiber such as a glass fiber.

In one embodiment, the carbon fibers of the first carbon fiber layer are arranged in a unidirectional orientation. That is, the carbon fibers of the first carbon fiber layer are arranged in parallel.

In another embodiment, the carbon fibers of the first carbon fiber layer are arranged in a multi-directional orientation. The carbon fibers of the first carbon fiber layer can be arranged at various orientations. For example, the carbon fibers are perpendicular (i.e. at an angle of 0/90 degrees off a reference axis); the carbon fibers are arranged at an angle of +45/−45 degrees off the reference axis, at an angle of +60/−60 degrees off the reference axis, or at any combination thereof. The reference axis is the output direction of the fibers.

Similarly, the carbon fibers of the second carbon fiber layer are arranged in a unidirectional orientation or in a multi-directional orientation. The carbon fibers of the second carbon fiber layer can be arranged at various orientations. For example, the carbon fibers are perpendicular (i.e. at an angle of 0/90 degrees off the reference axis); the carbon fibers are arranged at an angle of +45/−45 degrees off the reference axis, at an angle of +60/−60 degrees off the reference axis, or at any combination thereof.

Specifically, when the carbon fibers are arranged at an angle of +45/−45 degrees off the reference axis, each carbon fiber of the carbon fibers is at 90 degrees or 270 degrees relative to its adjacent carbon fiber of the carbon fibers. When the carbon fibers are arranged at an angle of +60/−60 degrees off the reference axis, each carbon fiber of the carbon fibers is at 120 degrees or 240 degrees relative to its adjacent carbon fiber of the carbon fibers.

More preferably, the carbon fibers of the first or second carbon fiber layer comprise at least two different arrangements at the same time. The at least two arrangements are at least two selected from the group consisting of: a parallel way, a perpendicular way, an intersecting way at an angle of +45/−45 degrees off the reference axis, an intersecting way at an angle of +60/−60 degrees off the reference axis, and any combination thereof. Therefore, the composite materials can adapt to the characteristics of different types of materials for footwear, or the composite materials can comply with requirements for different force modes or different strengths of stress.

### BRIEF DESCRIPTION OF THE DRAWING

FIG. 1 is a side cross-sectional view of a composite material of the present invention.

### DETAILED DESCRIPTION OF THE PREFERRED EMBODIMENTS

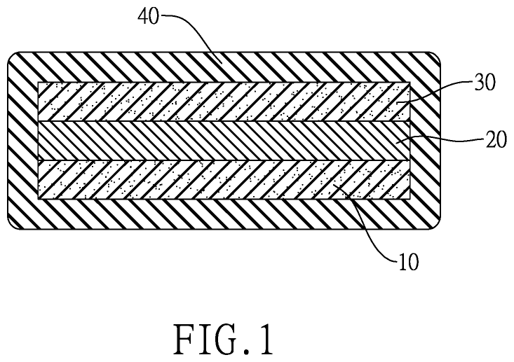

As illustrated in FIG. 1, the composite material of the present invention comprises a first carbon fiber layer 10, an intermediate layer 20, a second carbon fiber layer 30, and a resin body 40. The intermediate layer 20 is disposed between the first carbon fiber layer 10 and the second carbon fiber layer 30. The resin body 40 encloses the first carbon fiber layer 10, the intermediate layer 20, and the second carbon fiber layer 30.

The major materials of the first carbon fiber layer 10 are carbon fibers. The carbon fibers are preformed into a first carbon fiber cloth. The major materials of the intermediate layer 20 are aramid fibers. The aramid fibers are preformed into an aramid fiber cloth. The intermediate layer 20 can enhance the bendability of footwear, so it can compensate for the drawback of the carbon fibers, which is highly rigid but low in bendability. The major materials of the second carbon fiber layer 10 are carbon fibers. The carbon fibers are preformed into a second carbon fiber cloth.

In another embodiment, the first carbon fiber layer may further comprise glass fibers, aramid fibers, or any combination thereof. Similarly, the second carbon fiber layer also may further comprise glass fibers, aramid fibers, or any combination thereof.

The first carbon fiber layer 10, the intermediate layer 20, and the second carbon fiber layer 30 are sequentially disposed in a mold, and then the mold is preheated. Next, Polyamide 6 is injected to wrap the first carbon fiber layer 10, the intermediate layer 20, and the second carbon fiber layer 30. After Polyamide 6 is cooled and shaped to form the resin body 40, the composite material of the present invention is obtained.

In another embodiment, Polyamide 6 may be replaced by other polyamide resin such as Polyamide 66, a thermoplastic polyurethane resin, a polyetherimide resin, polysulfone resin, a polyphenylene sulfone resin, a polyethylene resin, a polycarbonate resin, an acrylonitrile-butadiene-styrene resin, or any combination thereof.

In addition, for meeting the requirement for the appearance of the composite material for footwear, the composite material for footwear may additionally comprise other inorganic fibers or organic fibers. Moreover, the color, shape or characteristics of the composite material for footwear may be adjusted.

The composite material for footwear of the invention has good wear resistance due to high mechanical strength of the first carbon fiber layer 10 and the second carbon fiber layer 30. Besides, the intermediate layer 20 of the composite material for footwear of the invention has a good cushioning ability, so it can improve the bendability of the whole composite material for footwear. Moreover, because the first carbon fiber layer 10, the intermediate layer 20, and the second carbon fiber layer 30 are enclosed by the resin body 40, the resin body 40 may fix and stabilize the first carbon fiber layer 10, the intermediate layer 20, and the second carbon fiber layer 30, and the resin body 40 can transfer the external force to the first carbon fiber layer 10 and the second carbon fiber layer 30. In addition, to meet the requirements for the appearance of various shoes, the first carbon fiber layer 10, the intermediate layer 20, and the second carbon fiber layer 30 can comprise additional fibers; to conform with the characteristics of footwear for various sports, and the resin body 40 can mix different resins.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A composite material for footwear comprising a first carbon fiber layer, a second carbon fiber layer, an intermediate layer, and a resin body;
wherein the first carbon fiber layer comprises multiple carbon fibers;
the second carbon fiber layer comprises multiple carbon fibers, and the second carbon fiber layer is disposed above the first carbon fiber layer;
the intermediate layer comprises an aramid fiber, a liquid crystal polymer fiber, or any combination thereof;
the intermediate layer is disposed between the first carbon fiber layer and the second carbon fiber layer; and
the first carbon fiber layer, the second carbon fiber layer, and the intermediate layer are enclosed by the resin body.

2. The composite material for footwear as claimed in claim 1, wherein the resin body comprises a polyamide resin, a thermoplastic polyurethane resin, a polyetherimide resin, a polysulfone resin, a polyphenylene sulfone resin, a polyethylene resin, a polycarbonate resin, an acrylonitrile-butadiene-styrene resin, or any combination thereof.

3. The composite material for footwear as claimed in claim 1, wherein the first carbon fiber layer further comprises glass fibers, aramid fibers, or any combination thereof.

4. The composite material for footwear as claimed in claim 1, wherein the second carbon fiber layer further comprises glass fibers, aramid fibers, or any combination thereof.

5. The composite material for footwear as claimed in claim 1, wherein the first carbon fiber layer is a first carbon fiber cloth, wherein the first carbon fiber cloth comprises the carbon fibers; and
the second carbon fiber layer is a second carbon fiber cloth, wherein the second carbon fiber cloth comprises the carbon fibers.

6. The composite material for footwear as claimed in claim 1, wherein the carbon fibers of the first carbon fiber layer are arranged in parallel.

7. The composite material for footwear as claimed in claim 3, wherein the carbon fibers of the first carbon fiber layer are arranged in parallel.

8. The composite material for footwear as claimed in claim 1, wherein the carbon fibers of the first carbon fiber layer are arranged at an angle of +45/−45 degrees off a reference axis, at an angle of +60/−60 degrees off the reference axis, or at any combination thereof.

9. The composite material for footwear as claimed in claim 3, wherein the carbon fibers of the first carbon fiber layer are arranged at an angle of +45/−45 degrees off a reference axis, at an angle of +60/−60 degrees off the reference axis, or at any combination thereof.

10. The composite material for footwear as claimed in claim 1, wherein the carbon fibers of the second carbon fiber layer are arranged in parallel.

11. The composite material for footwear as claimed in claim 4, wherein the carbon fibers of the second carbon fiber layer are arranged in parallel.

12. The composite material for footwear as claimed in claim 1, wherein the carbon fibers of the second carbon fiber layer are arranged at an angle of +45/−45 degrees off a reference axis, at an angle of +60/−60 degrees off the reference axis, or at any combination thereof.

13. The composite material for footwear as claimed in claim 4, wherein the carbon fibers of the second carbon fiber layer are arranged at an angle of +45/−45 degrees off a reference axis, at an angle of +60/−60 degrees off the reference axis, or at any combination thereof.

14. The composite material for footwear as claimed in claim 1, wherein the arrangements of the carbon fibers of the first and second carbon fiber layers are each independently at least two selected from the group consisting of: a parallel way, a perpendicular way, an intersecting way at an angle of +45/−45 degrees off a reference axis, an intersecting way at an angle of +60/−60 degrees off the reference axis, and any combination thereof.

15. The composite material for footwear as claimed in claim 2, wherein the arrangements of the carbon fibers of the first and second carbon fiber layers are each independently at least two selected from the group consisting of: a parallel way, a perpendicular way, an intersecting way at an angle of +45/−45 degrees off a reference axis, an intersecting way at an angle of +60/−60 degrees off the reference axis, and any combination thereof.

16. The composite material for footwear as claimed in claim 3, wherein the arrangements of the carbon fibers of the first and second carbon fiber layers are each independently at least two selected from the group consisting of: a parallel way, a perpendicular way, an intersecting way at an angle of +45/−45 degrees off a reference axis, an intersecting way at an angle of +60/−60 degrees off the reference axis, and any combination thereof.

17. The composite material for footwear as claimed in claim 4, wherein the arrangements of the carbon fibers of the first and second carbon fiber layers are each independently at least two selected from the group consisting of: a parallel way, a perpendicular way, an intersecting way at an angle of +45/−45 degrees off a reference axis, an intersecting way at an angle of +60/−60 degrees off the reference axis, and any combination thereof.
